(19) United States
(12) Patent Application Publication
(10) Pub. No.: US 2016/0198362 A1
(43) Pub. Date: Jul. 7, 2016

(54) SYSTEM AND METHODS FOR A MESH NETWORK UTILIZING SMART ANTENNAS

(71) Applicant: Thomas Freeburg, St. Charles, IL (US)

(72) Inventor: Thomas Freeburg, St. Charles, IL (US)

(21) Appl. No.: 14/989,680

(22) Filed: Jan. 6, 2016

Related U.S. Application Data
(60) Provisional application No. 62/100,392, filed on Jan. 6, 2015.
(60) Provisional application No. 62/113,274, filed on Feb. 6, 2015.

(51) Int. Cl. H04W 28/04; H04W 72/08; H04L 27/10; H01Q 21/00; H04W 72/10; H04W 24/08; H04B 17/318; H01Q 3/00; H04W 24/02; H04W 16/28

(52) U.S. Cl. CPC H04W 28/048; H04W 24/02; H04W 72/082; H04L 27/10; H04W 16/28; H04W 72/10; H04W 24/08; H04B 17/318; H01Q 3/00; H01Q 21/00; H04W 84/18

(57) ABSTRACT

A data transmission system, comprising a first node in a wireless communications network, the node comprising a radio frequency communications system having high resistance to interference. The radio frequency communications system is configured to measure an interference potential of a second node in the wireless communications network and arrange a priority and timing structure that maximizes reuse of available frequencies. The radio frequency communications system is also configured to encode and decode data and network control signals using a multi-level frequency shift keying modulation scheme. The node also comprising a directional and steerable antenna system, wherein the directional and steerable antenna system is capable of forming a radio frequency transmission into a beam directed to a desired target and transmitting a radiating omni-directional radio frequency transmission.

### CROSS-REFERENCE TO RELATED APPLICATIONS

This application is based on U.S. Provisional Patent Application Ser. No. 62/100,392 filed on Jan. 6, 2015 and entitled “SYSTEM AND METHODS FOR A MESH NETWORK UTILIZING SMART ANTENNAS” and U.S. Provisional Patent Application Ser. No. 62/113,274 filed on Feb. 6, 2015 and entitled “SYSTEM AND METHODS FOR A MESH NETWORK UTILIZING SMART ANTENNAS.”

### FIELD OF THE INVENTION

The present invention generally relates to mesh networks, and, more specifically to systems and methods for mesh networks utilizing smart antennas.

### BACKGROUND OF THE INVENTION

The emergence of HDTV has left a large swatch of spectrum in the 700 to 800 GHz area available for land mobile and associated uses. Unfortunately for many users, the cellular and public safety lobbies have succeeded in claiming almost all of this “prime” spectrum, leaving only a few small slices—each on the order of 1 MHz wide—for other uses.

### BRIEF DESCRIPTION OF THE DRAWINGS

FIG. 1 is a plot of bit error probability in accordance with various embodiments;

FIG. 2 is a plot of power-density spectrum in accordance with various embodiments;

FIG. 3 is a plot of power-density spectrum in accordance with various embodiments;

FIG. 4 is a plot of power-density spectrum in accordance with various embodiments;

FIG. 5 is a plot of power-density spectrum in accordance with various embodiments;

FIG. 6 is a plot of power-density spectrum in accordance with various embodiments;

FIG. 7 is a plot of power-density spectrum in accordance with various embodiments;

FIG. 8 is a plot of power spectra in accordance with various embodiments;

FIG. 9 is a plot of system performance in accordance with various embodiments;

FIG. 10 is a plot of system performance in accordance with various embodiments;

FIG. 11 is a plot of system performance in accordance with various embodiments;

FIG. 12 is a plot of system performance in accordance with various embodiments;

FIG. 13 is an illustration of an example system utilizing directional antennas in accordance with various embodiments;

FIG. 14 illustrates operation of a adaptive antenna in accordance with various embodiments;

FIG. 15 illustrates a system for processing adaptive antenna signals in accordance with various embodiments; and

FIG. 16 illustrates an example mesh network in accordance with various embodiments.

FIG. 17 is a plot of actual channel throughput as a function of the offered channel traffic.

FIG. 18 is a schematic diagram of a data transmission system in accordance with various embodiments.

### BRIEF SUMMARY OF INVENTION

The present disclosure, according to various embodiments, describes a method and system that are suited for applying this spectrum in a manner that an entity who needs data transmission over a large area, with virtually unlimited total throughput via very flexible frequency reuse, although needing only a moderate streaming rate to any one node. This can be accomplished through the present novel combination of system design elements.

According to various embodiments, novel combinations of elements in this disclosure include the following, as will be detailed in later sections:

Time-division duplex operation, with automatic selection among the available frequency slots.

The choice of Multi-level Frequency Shift Keying (M-FSK), to allow for maximum performance in interference, aiding with the very high frequency reuse that this system is capable of.

A novel method of medium access control that offers improved system throughput and stability, with less control overhead.

The use of directional antennas on both the Access Point and/or Client units, which also aids in maintaining improved frequency reuse.

The implementation of a self-directed mesh network, to minimize the number of Access Points required for complete area coverage and to maximize the overall data throughput capability.

Variable data rate, to allow larger cells as the system is first turned up. In one embodiment, the faster data rates may exhibit the same resistance to interference as the slower, unlike WiFi and cellular systems currently in use.

A modulation mechanism that allows two widely-spaced channels (wide in comparison to the width of the individual channels) to be bonded together to increase the streaming bit rate.

Intelligence in most if not all units to avoid causing interference. There is a small area around each cell site in adjacent spectrum (typically less than 500 feet in diameter) within which a station of our system operating in the band segments adjacent to the other system's receiver band can cause some interference to the other network. It should be noted that this interference is due, at least in part, to the limits of the receiver selectivity in the other system; even so, and according to various embodiments, the system can take steps to eliminate or reduce the problem.

### DETAILED DESCRIPTION OF THE PREFERRED EMBODIMENT

Choice of Modulation

A modulation format is the means by which information is encoded into a signal. Information, or data, can be carried in the amplitude, frequency, or phase of a signal. Modern communication systems use digital modulation techniques. Advancement in very large-scale integration (VLSI) and digital signal processing (DSP) technology have made digital modulation and coherent detection very cost effective. Digital transmissions also are convenient for the implementation of digital error-control codes signal conditioning and processing techniques such as source coding, encryption, and equalization to improve the performance of the overall communication link.

Many digital modulation techniques are used in modern wireless communication systems, and many more are sure to be introduced. Some of these techniques have subtle differences: for example, Frequency Shift Keying (FSK) may be either coherently or non-coherently detected; and may have two, four, eight or more possible levels per symbol.

Several factors influence the choice of a digital modulation scheme. A desirable modulation scheme provides low bit error rates at low received signal-to-noise ratios, performs well in multipath and fading conditions, is very resistant to interference, occupies a minimum bandwidth, and is easy and cost effective to implement. Unfortunately, existing modulation schemes do not simultaneously satisfy all of these requirements; some modulation schemes are better in terms of signal to noise performance, while others are better in terms of bandwidth efficiency

The performance of a modulation scheme can be expressed in terms of its power efficiency; its bandwidth efficiency; and its ability to reject interference; the latter in particular greatly affects frequency reuse. Power efficiency describes the ability of a modulation technique to preserve the fidelity of the digital message at low power levels. The power efficiency (sometimes called energy efficiency) of a digital modulation scheme is a measure of how favorable the tradeoff between fidelity and signal power is made, and is often expressed as the ratio of the signal energy per bit to noise power spectral density (Eb/No) required at the input of the receiver for a certain probability of error.

Bandwidth efficiency describes the ability of a modulation scheme to accommodate data within a limited bandwidth. In general, increasing the data rate implies decreasing the pulse width of a digital symbol, which increases the bandwidth of the signal. Thus, there is a strong relationship between data rate and bandwidth occupancy. However, some modulation schemes perform better than others in making this tradeoff. Bandwidth efficiency reflects how efficiently the allocated bandwidth is utilized and is defined as the ratio of the throughput data rate per Hertz in a given bandwidth. If R is the data rate in bits per second, and B is the bandwidth occupied by the modulated radio frequency signal, then bandwidth efficiency in one cell η_{B} is expressed as:

$$η B = \frac{R}{B} bps \text{/} Hz .$$

Ignoring reuse, in certain approaches the system capacity of a digital communication system is directly related to the bandwidth efficiency of the modulation scheme, since a modulation with a greater value of η_{B} will transmit more data in a given spectrum allocation.

There is a fundamental upper bound on achievable bandwidth efficiency. Shannon's channel coding theorem states that for an arbitrary small probability or error, the maximum possible bandwidth efficiency is limited by the noise in the channel, and is given by a particular channel capacity formula. This “Shannon's limit” for a non-fading channel in additive white Gaussian noise (AWGN) I is given by:

$$η Bmax = \frac{C}{B} = 2 ( 1 + \frac{S}{N} )$$

where C is the channel capacity in bits per second, B is the radio frequency (RF) bandwidth, and S/N is the signal-to-noise ratio.

Reuse, however, is an important system concept. The reuse capability of a given system is strongly related to its ability to reject interference; that is, the ratio of signal power to interfering power (C/I) required.

In the design of a digital communication system there is usually a tradeoff among bandwidth efficiency, power efficiency, and reuse. For example, adding error control coding to a message increases the bandwidth occupancy (and this, in turn, reduces the bandwidth efficiency), but at the same time reduces the required power for a particular bit error rate, and hence trades bandwidth efficiency for power efficiency. On the other hand, higher level modulation schemes (M-ary keying), except M-ary FSK, decrease bandwidth occupancy but increase the required received power, and hence trade power efficiency for bandwidth efficiency.

While power and bandwidth considerations are important, other factors also affect the choice of a digital modulation scheme. For example, for most communication systems that serve a large user community, the cost and complexity of the end-point devices should be minimized, and a modulation which is simple to detect is attractive. The performance of a modulation scheme under various types of channel impairments such as Rayleigh and Ricean fading and multipath time dispersion, given a particular demodulator implementation, is another factor in selecting a modulation. In wireless systems where interference is a major issue, the performance of a modulation scheme in an interference environment is also important. Sensitivity to detection of time jitter, caused by time-varying channels, is also an important consideration in choosing a particular modulation scheme.

Constant Envelope Modulation

Many practical radio communication systems use nonlinear modulation methods, where the amplitude of the carrier is constant, regardless of the variation in the modulating signal. The constant envelope family of modulations has the advantage of satisfying a number of conditions, some of which are:

Power efficient class C amplifiers can be used without introducing degradation in the spectrum occupancy of the transmitted signal.

Low out-of-band radiation of the order of −60 dB to −70 dB can be achieved.

Limiter-discriminator detectors can be used, which simplifies receiver design and provides high immunity against random amplitude modulation noise and signal fluctuations due to Rayleigh fading.

While constant envelope modulations have many advantages, they occupy a larger bandwidth than linear modulation schemes, and for that reason have been eschewed in many modern systems. However, in situations where large-scale bandwidth efficiency is important (e.g., systems that employ reuse), constant envelope modulation is especially well-suited.

FSK Signal and Modulator

In binary frequency shift keying (BFSK), the frequency of a constant amplitude carrier signal is switched between two values according to the two possible message states, corresponding to a binary 1 or 0. Depending on how the frequency variations are imparted into the transmitted waveform, the FSK signal will have either a discontinuous phase or a continuous phase at bit transmissions.

For coherent demodulation of the coherent FSK signal, the two frequencies are so chosen that the two signals are orthogonal and the phase is continuous as the signal switches from one to the other.

A disadvantage of coherent demodulation is that it requires knowledge of the reference phase or exact phase recovery, meaning local oscillators, phase-lock-loops, and carrier recovery circuits may be required, adding to the complexity of the receiver. Fortunately, this complexity is well within the capability of today's integrated circuit and DSP techniques.

In multilevel FSK (M-FSK) the carrier frequency is shifted among several different frequencies to represent the different bit combinations that make up the symbols. In practice, the frequency synthesizer generates M signals with the designed frequencies and coherent phase, and the multiplexer chooses one of the frequencies, according to the n=log₂ M bits.

The coherent M-ary FSK demodulator falls in the general form of detector for Mary equiprobable, equal-energy signals with known phases. The demodulator consists of a bank of M correlators or matched filters. At sample times t=kT, the receiver makes decisions based on the largest output of the correlators or matched filters

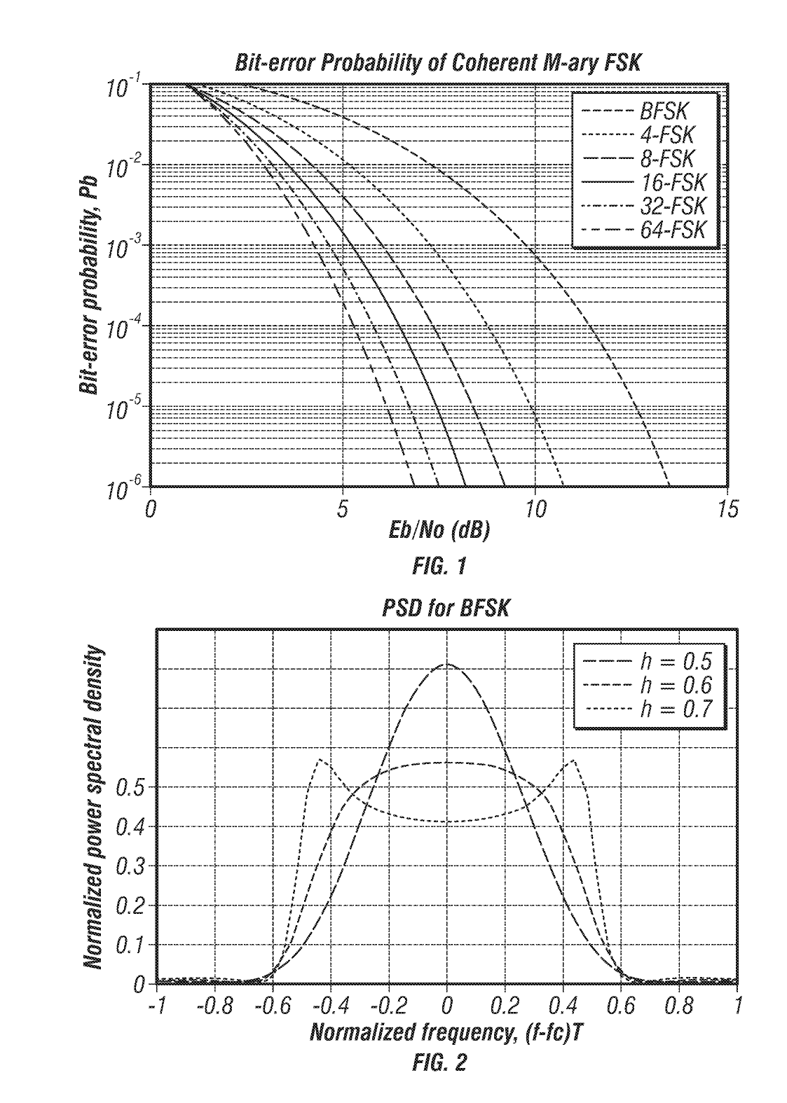

The bit error probability of M-FSK as a function of the bit signal to noise is shown in FIG. 1 for various levels of bits per symbol. Note especially that M-FSK is a good way to approach the limit defined by Shannon's Law.

We should note, however, that performance in terms of signal to noise, S/N, is but one factor in the system universe we are considering; rather, performance in signal to interference, S/I, controls the reuse factor according to various embodiments. We will discuss this much more in later sections.

Power Spectral Density

An important parameter of FSK modulation is the relationship of the frequency shift with symbol rate Rₛ (or equivalently the symbol period, T). This relationship is called the modulation index. The modulation index can be important because it often determines the ease of demodulation of the scheme and its spectral characteristics.

Often, in an M-ary FSK modulation, the binary data stream is divided into n-tuples of n=log₂ M bits. All the M possible n-tuples are denoted as M messages; m iᵢ, =1, 2, . . . , M. There are M signals with different frequencies to represent these M messages, and the expression for the ith signal is s tᵢ ( )=A cos(2πf tᵢ+φᵢ), 0≦t≦T, for mᵢ, where T is the symbol period which is n times the bit period.

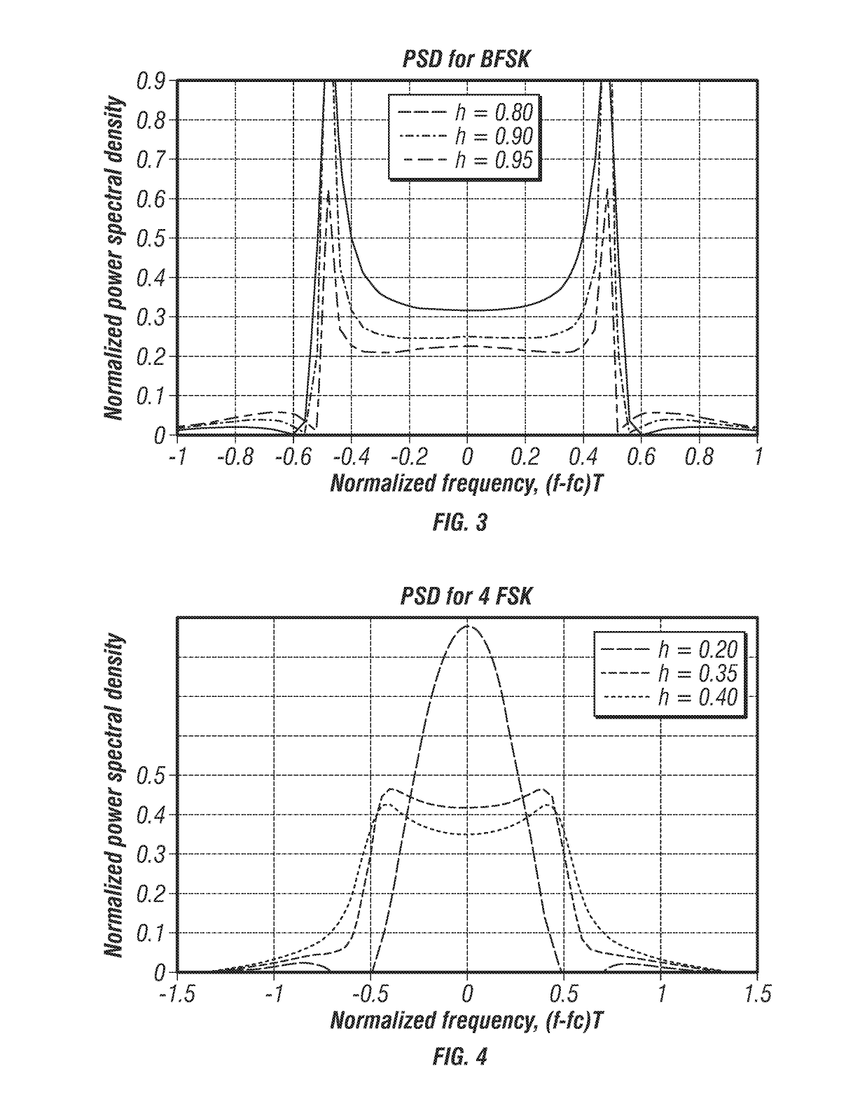

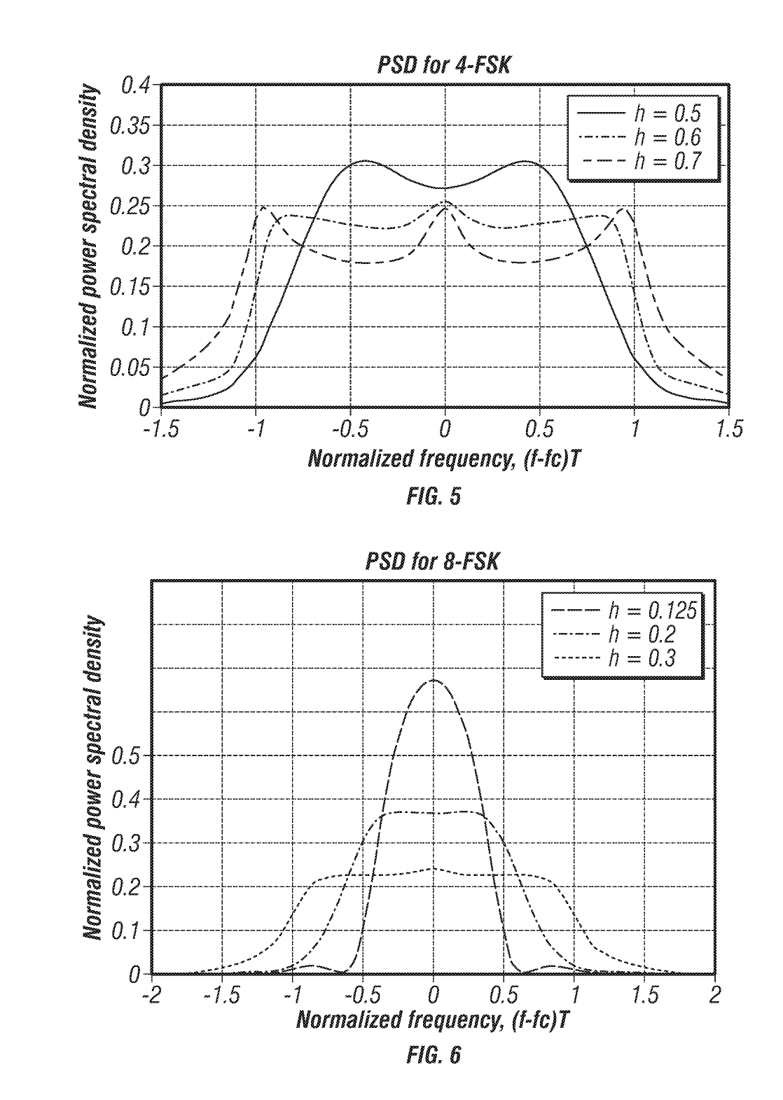

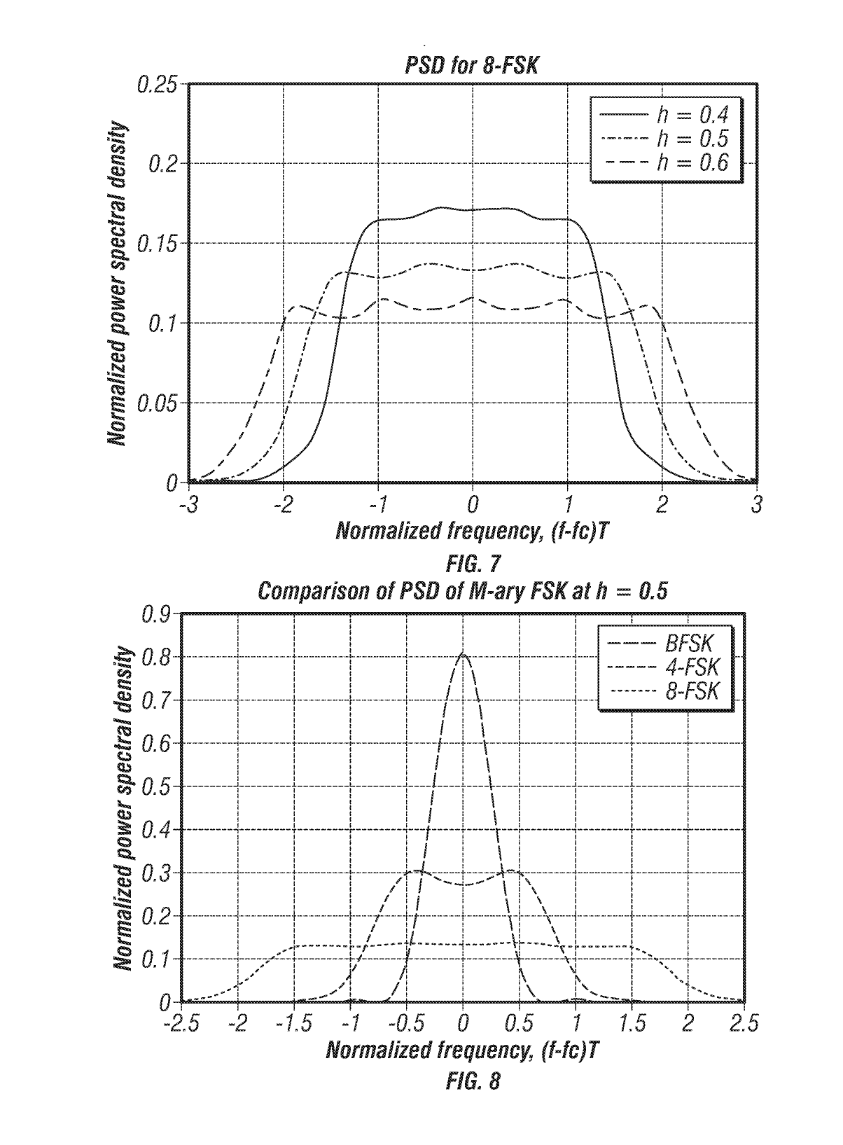

Plots of the power spectral density for various values of h for M=2, 4, and 8 are shown in FIGS. 3-7. FIG. 2 illustrates power-density spectrum of BFSK signal (for h=0.5, 0.6, 0.7), according to various embodiments. FIG. 3 illustrates power-density spectrum of BFSK signal (for h=0.8, 0.9, 0.95), according to various embodiments. FIG. 4 illustrates power-density spectrum of 4-FSK signal (for h=0.2, 0.35, and 0.4), according to various embodiments. FIG. 5 illustrates Power-density spectrum of 4-FSK signal (for h=0.5, 0.6, and 0.7), according to various embodiments. FIG. 6 illustrates power-density spectrum of 8-FSK signal (for h=0.125, 0.2, and 0.3), according to various embodiments. FIG. 7 illustrates power-density spectrum of 8-FSK signal (for h=0.4, 0.5, and 0.6), according to various embodiments.

Curves are presented for various values of h to show how the spectral shape changes with h. For small values of h, the spectra are narrow and decrease smoothly towards zero. As h increases towards unity, the spectrum widens and spectral power is increasingly concentrated around −0.5 (f−f_{c})≦0.5 and its odd multiples. These are the frequencies of the M signals in the scheme according to various embodiments.

FIG. 8 illustrates power spectra of M-ary FSK signals for M=2, 4, and 8 (h=0.5). For coherent orthogonal case, h=0.5, most spectral components are in a bandwidth of M/2T. Thus the transmission bandwidth is set as B_{T}=M/2T. Similarly, for noncoherent orthogonal case, h=1, and then B_{T}=M/T.

Bandwidth Efficiency

Channel bandwidth and transmit power constitute two important communication resources, efficient utilization of which provides the motivation for the search of efficient schemes. The goal of an efficient scheme is to achieve efficiency in bandwidth at a minimum practical expenditure of average transmit power or, equivalently a channel perturbed by AWGN, expenditure of average signal-to-noise ratio. The bandwidth efficiency is defined as the number of bits per second that can be transmitted in one Hertz of system bandwidth. With the data rate denoted by R_{b} and the channel bandwidth by B_{T}, we may express bandwidth efficiency, ρ, as

$$ρ = \frac{{R}_{b}}{{B}_{t}} \frac{bits}{sec} \text{/} Hz .$$

The data rate is well defined. Unfortunately, however, there is no universal satisfying definition for the bandwidth B_{T}. For modulation schemes that have power density spectral nulls, defining the bandwidth as the width of the main spectral lobe is a convenient way of bandwidth definition. If the spectrum of the modulated signal does not have spectral nulls, as in general continuous phase modulation, null-to-null bandwidth no longer exists. In this case energy percentage bandwidth may be used. Usually 99% is used, even though other percentages (e.g., 90%, 95%) are also used.

The bandwidth efficiency of coherently demodulated M-ary FSK signal that consists of an orthogonal set of M frequency-shifted signals is given by:

$$ρ = \frac{{R}_{b}}{\frac{M}{2} T} \frac{bits}{sec} \text{/} Hz \qquad [ Equation 1 ]$$

where R_{b} is the data rate in bits per second, and T is the symbol period which is n times the bit period.

Table1 gives the values of ρ calculated from Equation 1 for M=2, 4, 8, and 16.

TABLE 1
Bandwidth Efficiency of M-FSK

M

| | 2 | 4 | 8 | 16 |
|---|---|---|---|---|
| ρ | 1.0 | 1.0 | 0.75 | 0.50 |
| (bits/s/Hz) | | | | |

Performance in Interference

The above discussion covers S/N performance in a single cell. Another important point is the signal to interference performance. For convenience we will refer to this parameter as SJR in future, and to signal to noise, S/N, as SNR.

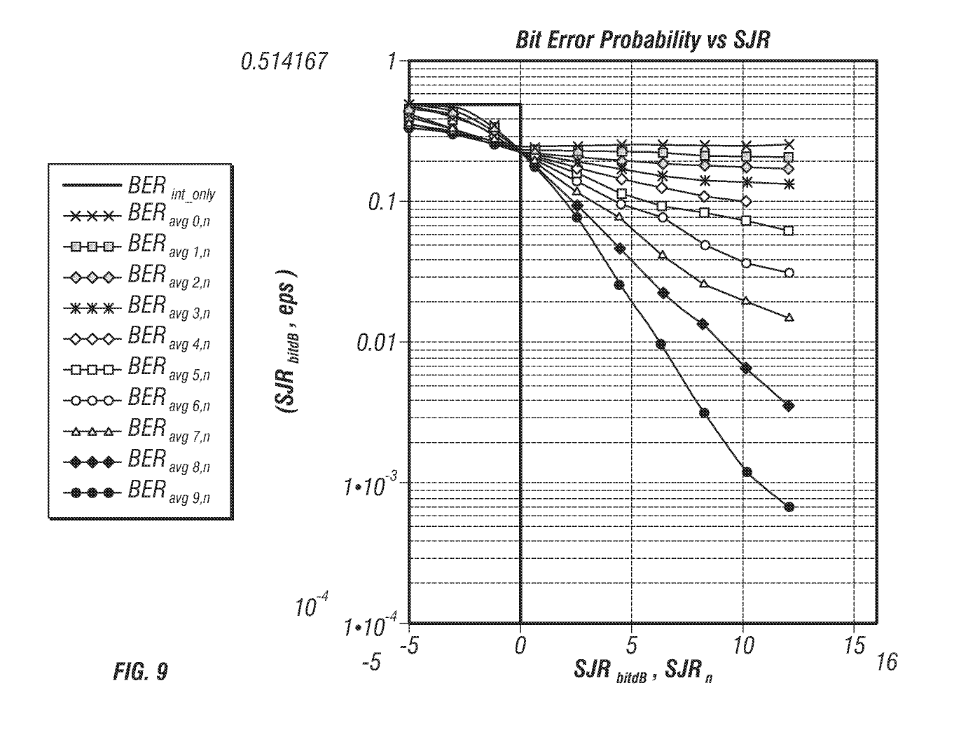

The beginning of this discussion is explored in FIG. 9, illustrating Performance in Interference and Noise of 2-FSK, in accordance with various embodiments. Each of the various lines represents a different fixed level of SNR. Ten levels of SNR are shown, ranging from −5 dB to +12 dB in steps of 1.89 dB. The solid line, which looks like a step function, is the probability of bit error when only interference is present. Note that it changes abruptly from about 0.5 to essentially zero at about −3 dB signal to interference (SJR).

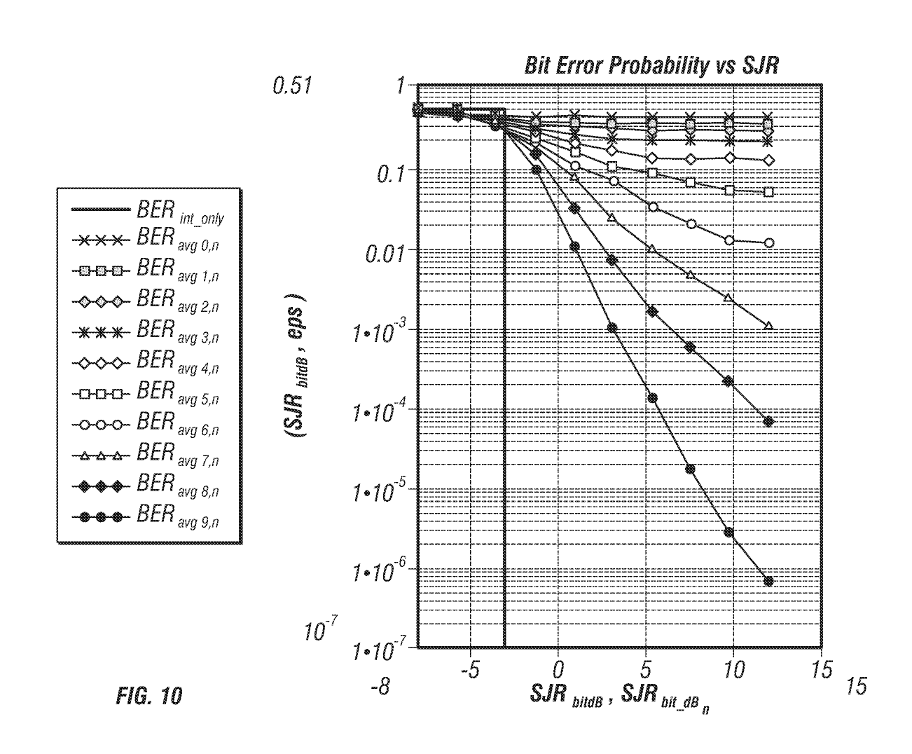

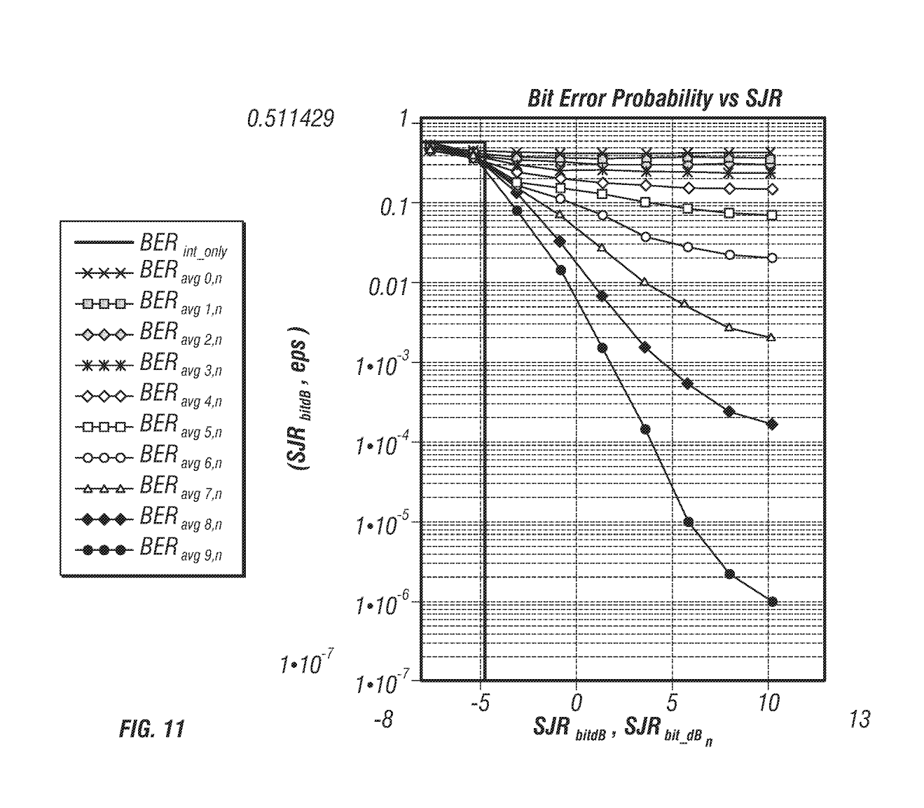

A similar set of curves is show in FIG. 10 for 4-FSK, and in FIG. 11 for 8-FSK, in accordance with various embodiments. Note that the signal to interference ratio for zero error moves to the left, toward poorer signal, as the bits per symbol increases.

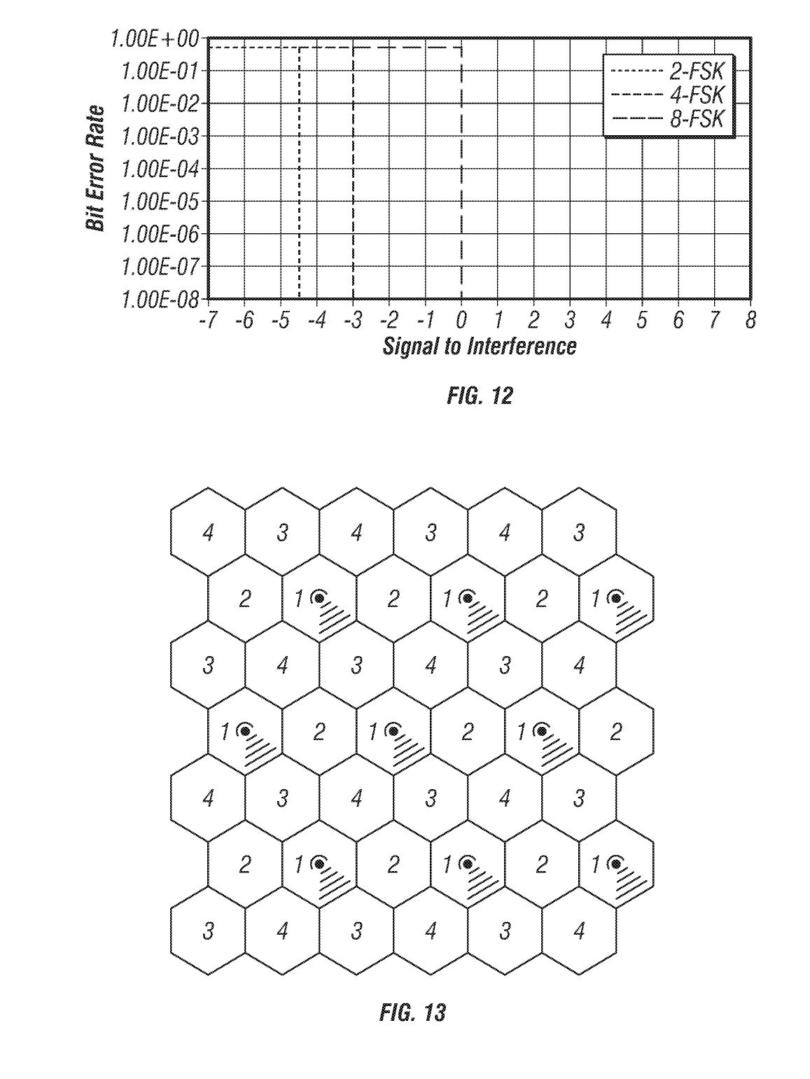

FIG. 12 shows the performance in interference-only situation for 2-, 4-, and 8-FSK, in accordance with various embodiments. Note that the Signal to Interference performance of 8-FSK is approximately −4.5 dB. In certain embodiments, in strong signal areas, it shows very low bit error rate when the interference is almost 3 time stronger than the signal.

Medium Access Control

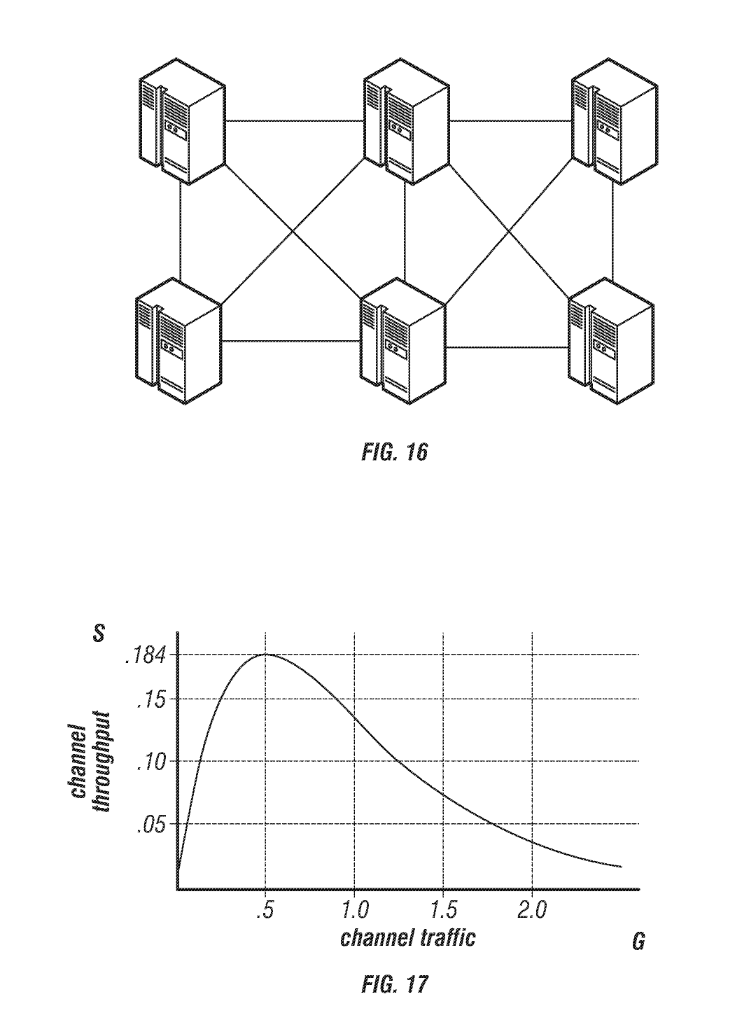

The simplest method of sharing access to a digital channel has long been understood. Commonly referred to as the ALOHA protocol, and first analyzed by Kleinrock, it consists of each terminal simply transmitting when it has data. This, in fact, works well as long as the traffic load is quite small. The usual assumptions, which underlie today's systems such as WiMax and WiFi, are that all messages are small, and that anytime two messages overlap both are lost. Under these conditions, the actual channel throughput as a function of the offered channel traffic follows the curve shown in FIG. 17; as per Kleinrock's analysis, the maximum throughput is 18.4%.

This throughput is not particularly impressive, and there is another very negative effect: note that the portion of the curve to the right of the maximum shows a sort of negative returns tendency. This means that the common technique of causing the transmitting terminal to retry its message if it fails to receive an acknowledgement can very easily drive the system toward more and more offered channel traffic, and less and less throughput. Indeed, many early data systems that relied on ALOHA access exhibited a tendency to “crash”—to enter a mode where they got busier and busier while carrying little or no useful traffic. That is, they were generally unstable.

The radio system described herein offers a solution. Due to the great resistance to interference that the chosen modulation system affords, the probability is very high that in the event of a collision—that is, of the transmissions of two terminals overlapping—one of them will be received. In the case where the required signal to interference ratio is unity (0 dB) or better, that probability is unity—one will always be received. Indeed, this case is quite practical with the system described herein.

There is another and heretofore unrecognized improvement possible in this situation. If the system includes two or more base station receivers separated by some distance, then in many instances of two terminals transmitting at once both will be received, one by the first receiver and the other by the second. If this can be made to happen reliably, then the channel throughput can be considerably more than 100 percent.

The separation between the receivers need only be enough to assure that the radio-frequency path loss difference between the two paths from a given terminal to the two receivers be largely uncorrelated, which requires a fairly small separation in the case of urban systems.

Channel Bonding

There are many instances where the peak data rate to a single point is an important factor. In these instances and in accordance with various embodiments, the system described here can implement simultaneous modulation on two or more disparate spectrum slices. This can be implemented in at least one of the following two example ways:

1—Use a separate transmitter and/or receiver for each spectrum slice; for instance one at 462 MHz and another at 467.

2—Utilize modulation and demodulation circuitry that is capable of generating/decoding the appropriate signals directly. For instance, the common complex modulation system that generates the 90-degree separated signals mathematically can be configured to confine the modulation products to two or more disparate frequency segments.

Receivers and transmitters using this latter scheme can, in one example, be implemented where the modulation format for each spectrum segment is the M-ary FSK described earlier. Further, for cases where high streaming throughput is desired in combination with resistance to multipath fading, Orthogonal Frequency Division Multiplex (OFDM) may be used, as specified in the IEEE 802.11ac specification, modified to set the individual carriers in the space between the spectrum segments to be used to zero.

Conceptually, OFDM is a specialized Frequency Division Multiplex (FDM), the additional constraint being that all the carrier signals are orthogonal to each other. In OFDM, the sub-carrier frequencies are chosen so that the sub-carriers are orthogonal to each other, meaning that cross-talk between the sub-channels is eliminated and inter-carrier guard bands are not required. This simplifies the design of both the transmitter and the receiver. For example, unlike conventional FDM, a separate filter for each sub-channel is not required.

The orthogonality allows for efficient modulator and demodulator implementation using the FFT algorithm on the receiver side, and inverse FFT on the sender side. In certain approaches, the use of OFDM can be beneficial in that it provides wideband communications using low-cost digital signal processing components that can efficiently calculate the FFT.

OFDM utilizing M-ary Quadrature Amplitude Modulation on each of the sub-carriers is capable of very high throughputs. However, it should be noted that in some approaches, its use may suffer from two drawbacks: requiring completely or near completely linear receiver and transmitter radio-frequency stages, and offering poorer performance in interference than M-FSK, thereby limiting frequency reuse.

Antennas

It is common practice today to use directional antennas at the fixed station location, allowing a number of independent transmitter and receiver systems. For instance, Graziano describes in U.S. Pat. No. 4,128,740 a “Center Illuminated Sector Cell System” that relies on directional antennas at the cell site, as shown in FIG. 13.

Further, directional antennas are often used on client units in fixed-to-fixed system. However, that is often for purposes of increased system gain (range). The effect on reuse is typically ignored.

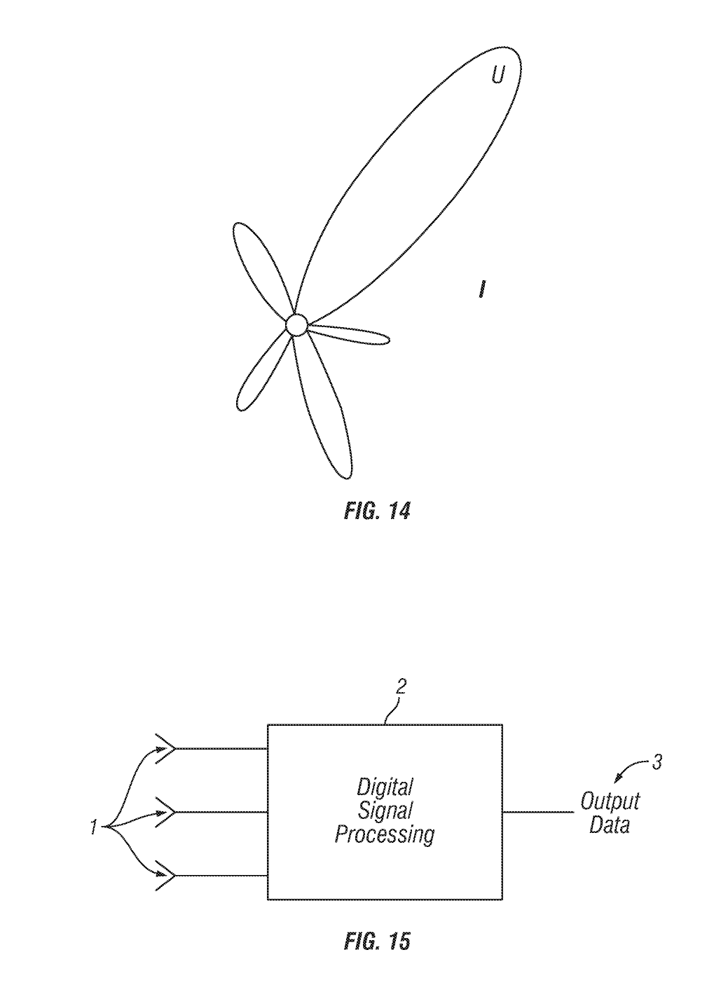

Modern digital technology has an answer—the smart antenna. Essentially, an array of simple antenna elements is used (e.g., 3 or more antenna elements), and the outputs/inputs are processed digitally to focus the resultant beam in the desired direction. This is shown in FIG. 14, illustrating adaptive “smart” antenna in accordance with various embodiments.

FIG. 15 illustrates smart antenna operation in accordance with various embodiments. The several antennas 1 connect to a digital processing element 2, which combines the antenna outputs into a single receiver beam and extracts the output data 3. In the transmit case, the input data is fed to the digital signal processing element 2, which transforms it into the precise signals necessary to form the appropriate directional beam from the several antennas 1.

Mesh Network

In various embodiments, a mesh network is a network in which each node can act as an independent router, regardless of whether it is connected to another network or not. Such a network in theory allows for reconfiguration around broken or blocked paths by “hopping” from node to node until the destination is reached. An example mesh network is shown in FIG. 16, in accordance with various embodiments.

A network in which each node is directly connected to all other nodes is called a directly connected mesh network. For large networks, this obviously carries a large expense, as the number of links grows as the square of the number of nodes. For this reason, it is common to use a partially connected mesh.

Mesh networks that can be reconfigured on the fly to accommodate broken or added links, or new or missing nodes, are commonly referred to as ad hoc mesh networks, or more correctly as dynamic ad hoc mesh networks. Often, these are implemented with wireless links, and therefore are wireless dynamic ad hoc mesh networks, although it has become common to use the term wireless mesh, implying the dynamic and ad hoc terms. A wireless mesh network (WMN) is therefore a communications network made up of radio nodes organized in a mesh topology.

There are at least three variations on the mechanism for controlling the topology of a WMN. The first and simplest is a pre-planned layout, in which the link that each node follows to reach any other node is specified and fixed as the node is installed. This is can be somewhat difficult for large networks, and may not allow dynamic rerouting to bypass failed links. The second variation, which has been followed by several large companies offering networks and network equipment for sale, utilizes a central server to control the routing. This has an advantage of allowing connectivity changes to bypass failed links, and allows the central control that is desired by many large carriers.

The third variation is a self-managed scheme, where each node includes decision logic such that the nodes interact to choose the interconnecting routes. Within this category, there are a large number of algorithms for gathering the necessary data, making the routing decisions, and keeping the routing information so that it is available when needed.

Another area of distinction among the various schemes revolves around the configuration of the individual nodes and how they connect to the Internet proper and to the users. In certain approaches, there are at least 5 connection types that a mesh network can manage, as follows:

Data connections to the Internet;

Data connections to the users;

Data connections to other nodes;

Data connections to other mesh networks; and

Connections for control data (such as mesh configuration) among the nodes.

Although the first connection to the greater Internet is usually assumed to be a wire of some sort, there are examples of all possible combinations of the other four, ranging from four separate radios on separate frequencies to a single radio and protocol stack serving all four functions. The reasons usually given for multiple radios turn out to be based on the relative inefficiency of the commonly-used 802.11 protocol under conditions of high traffic and high interference. This limitation can often be overcome by the careful selection of another protocol, or by a number of techniques to improve the operation.

According to various embodiments, the instant approach includes radio equipment with high resistance to interference, and directional, steerable antennas on all or most nodes. The place of each of these elements in our overall scheme is expanded in the following sections.

Resistance to Interference

Resistance to interference is often an important aspect of radio performance, particularly in reuse-based system such as cellular and mesh. Understanding of performance in this arena allows a mesh network implementation to take advantage of reuse distances that would otherwise be impossible. In fact, in previous solutions, it is an inherent assumption in design of existing mesh products that any interference is destructive and therefore not to be allowed. This flows from the basic underpinnings of the 801.11 protocol, which was designed with little regard to the actual mechanisms of interference.

In contrast, and in accordance with various embodiments, the instant system measures the interference potential of most or all nearby nodes, and arranges a priority and timing structure that maximizes reuse of the frequency and timeslots available.

Directional, Steerable Antennas

In various embodiments, all or some nodes in the system described herein include an antenna system that is capable of very quickly or approximately instantaneously forming a beam aimed at the desired target, or alternatively exhibiting omni-directional capabilities. This means that the dedicated logical network that corresponds to the control layer can be aware of surrounding nodes and the universe of possible links, while the data transport logical network can be focused on those links that are most efficient for the carriage in question.

Range and Bearing Measurement

With the smart antenna system, determination of range and bearing to the neighboring nodes becomes a matter of simple computation.

Separate Logical Networks for Control and for Data Transmission

In certain embodiments, the system optionally includes a logical separation of the control information from the data transmission. This separation extends to providing a dedicated time-slice of the radio channel for the control spectrum, thereby allowing management of that logical network in a manner that is independent of the data transmission.

This allows the independent optimization of the conflicting demands of the two networks: omni-directional connectivity to neighboring nodes (e.g., all or most neighboring nodes) for the control network, and optimization of reuse (interference), available throughput, and range (to minimize the number of required hops and therefore latency) for the data transmission network.

Variable Data Rate

Variable data rate may be utilized in the instant system, in accordance with various embodiments. For instance, variable data rate is embedded in the specifications for WiFi, and the WiFi implementation establishes the data rate to be used by sending periodic trials at various rates and determining their success or failure. Such a technique may be adequate for the system described here in various embodiments.

Interference to Other Systems

As discussed herein, there are often systems using different technologies in broad swaths of adjacent spectrum. These systems are expected to use the spread-spectrum technology known as LTE, and to operate in frequency-division-duplex mode.

There is a small area around each cell site in adjacent spectrum within which a station of our system operating in the band segments adjacent to the other system's receiver band can cause some interference to the other network. It should be noted that this interference is due entirely or in part to the limits of the receiver selectivity in the other system. Even so, in certain approaches it is important that our system take steps to eliminate the problem.

None the less, this is a problem for the other system, and we might be considered remiss in not addressing it. A free-space calculation shows that, for example, the 15 dB of further attenuation required to protect the other system's receiver requires a separation of about 1000 feet for one of our systems aimed directly at their cell site. This means that this problem is a concern for less than 3% of the system area, assuming a one-mile cell radius for our system, and that every cell has a site of the other system near our AP location.

One solution is to use other frequencies for those problem sites. In another approach, the AP radio may be designed in such a way that it can listen for nearby LTE transmitters, and then appropriately avoid the associated LTE receivers.

In one embodiment, shown in FIG. 18, a wireless communications network 50 comprises a first node 100, a second node 200, and a mobile device 300. First and second nodes 100, 200 may be fixed base stations. In mobile telephony a base station provides the connection between mobile phones and the wider telephone network. In a computer network a base station is a transceiver acting as a router for computers in the network, possibly connecting them to a local area network and/or the internet.

First node 100 comprises a radio frequency communications system 102, and a directional and steerable antenna system 104. The radio frequency communications system 102 is configured to measure an interference potential of the second node 200 and arrange a priority and timing structure that maximizes the reuse of available frequencies and timeslots. This is accomplished through the use of a processor 106 that responds to the radio frequency communications system 102 and measures the interference potential of surrounding nodes, such as second node 200.

This is easily accomplished by measuring the signal strength of the neighboring node, and potentially comparing it to the strength of a known and/or desired faraway node. The interference potential is therefore related to the measured signal strength, plotted against the required interference level of the receiver, potentially using the signal from the faraway node as a reference point.

To maximize the reuse of available frequencies and timeslots, radio frequency communications system 102 may, for example, have a plurality of pre-loaded frequency and timeslot options that correspond to a given interference potential and that act to maximize system performance for the given interference level. Once provided with the specific interference potential, the radio frequency communications system would then select the pre-loaded, corresponding frequency and timeslot option that maximizes performance of the system. In one method of maximizing the frequency utilization, the system would operate with an overall system-wide timing cycle. All nearby nodes would be categorized by measuring their signal strengths and their transmission times within the overall system timing cycle. Transmissions to other nodes would then be timed within the overall timing cycle so as to avoid segments that would be interfered with by nodes whose signals are stronger than that of the target node.

In another implementation, nodes would exchange information with nearby nodes representing potential data targets, sharing information to allow transmitting nodes to avoid interference from other nodes. Note that conventional system design, where in the case of simultaneous transmission both messages are lost, neither of these schemes would yield any benefit.

The radio frequency communications system 102 has a high resistance to interference, which is based on its use of the multi-level frequency shift keying modulation scheme, as previously described. This high resistance to interference trivializes other means of limiting mutual interference among nodes, as in the other means of limiting mutual interference among nodes are potentially not needed. In one embodiment, trivializes means that the use of other means of limiting mutual interference among nodes, besides just the use of the multi-level frequency shift keying modulation scheme, results in negligible improvement to system throughput and stability. Additionally, the radio frequency communications system 102 may use modulation and demodulation circuitry to generate and/or decode the appropriate signals directly. For instance, as previously described, the common complex modulation system that generates the 90-degree separated signals mathematically can be configured to confine the modulation products to two or more disparate frequency segments.

The steerable antenna system 104 comprises an array 108 of simple antenna elements, forming a smart antenna. Smart antennas (also known as adaptive array antennas, multiple antennas and, recently, MIMO) are antenna arrays with smart signal processing algorithms used to identify spatial signal signature such as the direction of arrival (DOA) of the signal, and use it to calculate beamforming vectors, to track and locate the antenna beam on the mobile/target. The steerable antenna system 104 is also capable of transmitting an omni-directional radio frequency transmission. In radio communication, an omnidirectional antenna is a class of antenna which radiates radio wave power uniformly in all directions in one plane, with the radiated power decreasing with elevation angle above or below the plane, dropping to zero on the antenna's axis. This radiation pattern is often described as “doughnut shaped”. Note that this is different from an isotropic antenna, which radiates equal power in all directions and has a “spherical” radiation pattern. Omnidirectional antennas oriented vertically are widely used for nondirectional antennas on the surface of the Earth because they radiate equally in all horizontal directions, while the power radiated drops off with elevation angle so little radio energy is aimed into the sky or down toward the earth and wasted. Omnidirectional antennas are widely used for radio broadcasting antennas, and in mobile devices that use radio such as cell phones, FM radios, walkie-talkies, wireless computer networks, cordless phones, GPS as well as for base stations that communicate with mobile radios.

Similar to the first node 100, second node 200 comprises a radio frequency communications system 202, and a directional and steerable antenna system 204. The radio frequency communications system 202 is configured to measure an interference potential of the other surrounding nodes and arrange a priority and timing structure that maximizes the reuse of available frequencies or timeslots, as described earlier. This is accomplished through the use of processor 206 that responds to the radio frequency communications system 202 and measures the interference potential of surrounding nodes, such as first node 100. The radio frequency communications system 202 has a high resistance to interference which is based on its use of the multi-level frequency shift keying modulation scheme, as previously described. The directional and steerable antenna system 204 comprises an array 208 of simple antenna elements, that form a smart antenna.

Similar to the first and second nodes 100, 200, the mobile device 300 may also comprise a smart antenna 302 and may have corresponding hardware and software necessary to operate the smart antenna 302.

In transmissions between the first node 100 and the second node 200 represented by the double arrow 450, there may be a logical separation between transmissions of the data signals 400 and the network control signals 500. The data signals 400 refer to the signals that contain the communication information. The network control signals 500 refer to the signals that contain commands and instructions to be used by the different components of the wireless communications network 50. Further, in one embodiment, the data signals 400 may be transmitted by the directional and steerable antenna systems 104, 204 as radio frequency transmissions in a beamform directed at a desired target. And the network control signals 500 may be transmitted as an omni-directional radio frequency transmission.

The present invention has been described in terms of one or more preferred embodiments, and it should be appreciated that many equivalents, alternatives, variations, and modifications, aside from those expressly stated, are possible and within the scope of the invention.

I claim:

1. A data transmission system, comprising:
a first node in a wireless communications network, the node comprising:
a radio frequency communications system having a high resistance to interference, said high resistance to interference being sufficient to trivialize other means of limiting mutual interference among nodes.

2. The data transmission system according to claim 1, wherein the radio frequency communications system is configured to implement a logical separation between transmissions of data and network control signals.

3. The data transmission system of claim 1 further comprising a directional and steerable antenna system, wherein the directional and steerable antenna system is capable of forming a radio frequency transmission into a beam directed to a desired target and transmitting a radiating omni-directional radio frequency transmission.

4. The data transmission system of claim 3,
wherein the radio frequency communications system is configured to implement a logical separation between transmissions of data and network control signals; and
wherein the directional and steerable antenna system is configured to transmit the data signal as radio frequency transmissions in the beam directed to a desired target and the network control signal as the radiating omni-directional radio frequency transmission.

5. The data transmission system of claim 1 wherein the radio frequency communications system utilizes a modulation and demodulation circuitry.

6. The data transmission system of claim 1, wherein the radio frequency communications system is configured to utilize digital Frequency-Shift transmission to achieve very high resistance to interference and utilizes that very high resistance to achieve one- or two-frequency cellular reuse.

7. The data transmission system of claim 1, wherein the radio frequency communications system is configured to utilize digital Frequency-Shift transmission to achieve very high resistance to interference and utilizes that very high resistance to achieve single frequency cellular reuse using only one or two timeslots.

8. The data transmission system of claim 1, wherein the radio frequency communications system is configured to measure a first signal strength of a second node, and compare it to a second signal strength of a third node.

9. A data transmission system, comprising:
a first node in a wireless communications network, the node comprising:
a radio frequency communications system having high resistance to interference, wherein the radio frequency communications system is configured to:
measure an interference potential of a second node in the wireless communications network and arrange a priority and timing structure that maximizes reuse of available frequencies, and
wherein the radio frequency communications system is configured to encode and decode data and network control signals using a multi-level frequency shift keying modulation scheme, and
a directional and steerable antenna system, wherein the directional and steerable antenna system is capable of forming a radio frequency transmission into a beam directed to a desired target.

10. The data transmission system of claim 9 wherein the radio frequency communications system is configured to implement a logical separation between transmissions of data and network control signals.

11. The data transmission system of claim 9 wherein the radio frequency communications system utilizes a modulation and demodulation circuitry.

12. The data transmission system of claim 9, wherein the radio frequency communications system is configured to utilize digital Frequency-Shift transmission to achieve very high resistance to interference and utilizes that very high resistance to achieve one- or two-frequency cellular reuse.

13. The data transmission system of claim 9, wherein the radio frequency communications system is configured to utilize digital Frequency-Shift transmission to achieve very high resistance to interference and utilizes that very high resistance to achieve single frequency cellular reuse using only one or two timeslots.

14. The data transmission system of claim 9, wherein the radio frequency communications system is configured to measure the interference potential of the second node by measuring a first signal strength of the second node and comparing it to a second signal strength of a third node.

15. A data transmission system, comprising:
a first node in a wireless communications network, the node comprising:
a radio frequency communications system having high resistance to interference, wherein the radio frequency communications system is configured to:
measure an interference potential of a second node in the wireless communications network and arrange a priority and timing structure that maximizes reuse of available frequencies, and
wherein the radio frequency communications system is configured to encode and decode data and network control signals using a multi-level frequency shift keying modulation scheme, and
a directional and steerable antenna system, wherein the steerable antenna system is capable of transmitting a radiating omni-directional radio frequency transmission.

16. The data transmission system of claim 15 wherein the radio frequency communications system is configured to implement a logical separation between transmissions data and network control signals.

17. The data transmission system of claim 15 wherein the radio frequency communications system utilizes a modulation and demodulation circuitry.

18. The data transmission system of claim 15, wherein the radio frequency communications system is configured to utilize digital Frequency-Shift transmission to achieve very high resistance to interference and utilizes that very high resistance to achieve one- or two-frequency cellular reuse.

19. The data transmission system of claim 15, wherein the radio frequency communications system is configured to utilize digital Frequency-Shift transmission to achieve very high resistance to interference and utilizes that very high resistance to achieve single frequency cellular reuse using only one or two timeslots.

20. The data transmission system of claim 15, wherein the radio frequency communications system is configured to measure the interference potential of the second node by measuring a first signal strength of the second node and comparing it to a second signal strength of a third node.
